(19) United States
(12) Patent Application Publication
(10) Pub. No.: US 2020/0310523 A1
(43) Pub. Date: Oct. 1, 2020

(54) User Request Detection and Execution

(71) Applicant: Motorola Mobility LLC, Chicago, IL (US)

(72) Inventors: Thomas Merrell, Chicago, IL (US); Jarrett Simerson, Chicago, IL (US)

(73) Assignee: Motorola Mobility LLC, Chicago, IL (US)

(21) Appl. No.: 16/362,829

(22) Filed: Mar. 25, 2019

(51) Int. Cl. G06F 1/3231; G06F 1/3296; G06F 3/16

(52) U.S. Cl. CPC G06F 1/3231; G06F 3/167; G06F 1/3296

(57) ABSTRACT

Systems and methods for user request detection and execution in a mobile electronic communications device entail using a low power request detection module in conjunction with a high power request detection module. The low power request detection module detects speech, determines that the detected speech is that of an authorized user and determines that the speech contains a request. The low power request detection module then awakens the high power request detection module from idle, which then determines with a higher confidence threshold that the speech of the authorized user contains a request and the interprets and executes the request.

### TECHNICAL FIELD

The present disclosure is related generally to mobile electronic communications devices and, more particularly, to systems and methods for facilitating spoken user interactions with mobile electronic communications devices.

### BACKGROUND

The introduction of “smart” phones, or full-feature mobile phones, served to make the mobile phone a required accessory for most people. Mobile phones could now be used for business, entertainment, social interactions, shopping and more. Hardware keypads eventually gave way to touch-screen keypads, and now, voice-to-text conversion has become a popular alternative to text entry. However, voice entry of information and commands remains somewhat stilted and inconvenient

For example, some current systems require the user to utter a “trigger word” or “trigger phrase” in order to begin speech recognition. These solutions require the user to say the exact trigger word or phrase, wait for the system to recognize the event, and then the user may say what it is they wish the system to do. Other solutions constantly surveil the user to try to determine when the user is speaking to the device. However, such systems tend to energy inefficient and are prone to a higher level of falsing than trigger-based solutions.

Before proceeding to the remainder of this disclosure, it should be appreciated that the disclosure may address some or all of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to be, to accurately catalog, or to comprehensively summarize any prior art reference or practice. As such, the inventors expressly disclaim this section as admitted or assumed prior art. Moreover, the identification or implication herein of one or more desirable courses of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a general schematic representation of a mobile electronic device in which various embodiments of the disclosed principles may be implemented;

FIG. 2 is a simplified schematic showing interconnected modules in accordance with an embodiment of the disclosed principles;

FIG. 3 is a simplified schematic showing interconnected modules in accordance with another embodiment of the disclosed principles;

FIG. 4 is a table showing example structural elements of request in accordance with an embodiment of the disclosed principles;

FIG. 5 is a flow chart showing a process of tiered voice detection and processing in accordance with an embodiment of the disclosed principles; and

FIG. 6 is a flow chart showing an alternative process of tiered voice detection and processing in accordance with another embodiment of the disclosed principles.

### DETAILED DESCRIPTION

Before presenting a detailed discussion of embodiments of the disclosed principles, an overview of certain embodiments is given to aid the reader in understanding the later discussion. As noted above, voice entry of data or commands to a mobile electronic device is currently highly inefficient, stilted or both. Some systems somewhat awkwardly require a specific and precise word phrase to be uttered before any entry can commence, while other systems operate at an inordinate power level in order to constantly surveil the user in an attempt to determine when the user is speaking to the device.

In an embodiment of the disclosed principles, a more natural user interaction is enabled while also operating at a lower power level than that required by a typical “constant surveillance” system. In particular, a multi-tiered approach is employed in an embodiment of the disclosed principles, wherein low power elements gate the execution of tasks by higher power elements. The lower elements are not as capable or accurate as the higher power elements, but the combined result of the tiered low-power and high-power elements is able to use very little power while also providing an enhanced and more natural user experience.

As noted above, different system components can be employed to reach a similar result as long as they follow the described tier-based principles. However, in one embodiment, the system is composed of several components Low power components and several high power components. The low power components in this embodiment include a Speech Detector (LP-SD), User Identifier (LP-UID), Frontend Speech Signal Processor (LP-FSSP), Request Identifier (LP-RID) and Context Monitor (LP-CM).

In this embodiment, the LP-SD is configured to receive an audio signal and to detect speech from among other potential audio features, and the LP-UID is configured to discriminate between the authorized user of the device as opposed to other speakers. The LP-FSSP isolates the authorized user's speech and filters out other speakers, echoes, and miscellaneous noise. From the output of the LP-FSSP, the LP-RID identifies a request structure, if any, consisting of an anchor word, as well as zero to many modifier words, and zero to many other words.

The LP-CM is configured to monitor context, e.g., the occurrence of contextual events within a specified temporal relationship to each other, and report on such occurrence to the high power request manager (HP-RM) when appropriate, as will be detailed later herein.

As noted above, the example system also includes a number of high power components. These include the HP-RM, as well as a Request Identifier (HP-RID) and Request Decoder (HP-RD). The HP-RID identifies request structure, if any, within processed audio, consisting of an anchor word, zero to many modifier words, and potentially other words as well. The HP-RD parses the request into its component parts and translates it into an actionable string. Finally, the HP-RM manages the fulfillment of any identified requests.

In an embodiment, the HP-RM also coordinates with the LP-CM to detect when requests include an inherent delayed or scheduled execution. An example of a request having an inherent delayed execution would be something like “remind me to pick up milk on the way home.” From this, the HP-RM sets a prerequisite event (e.g., user is on the way home) as a trigger to execute the task (e.g., remind the user to pick up milk).

With this overview in mind, and turning now to a more detailed discussion in conjunction with the attached figures, the techniques of the present disclosure are illustrated as being implemented in or via a suitable device environment. The following device description is based on embodiments and examples within which or via which the disclosed principles may be implemented, and should not be taken as limiting the claims with regard to alternative embodiments that are not explicitly described herein.

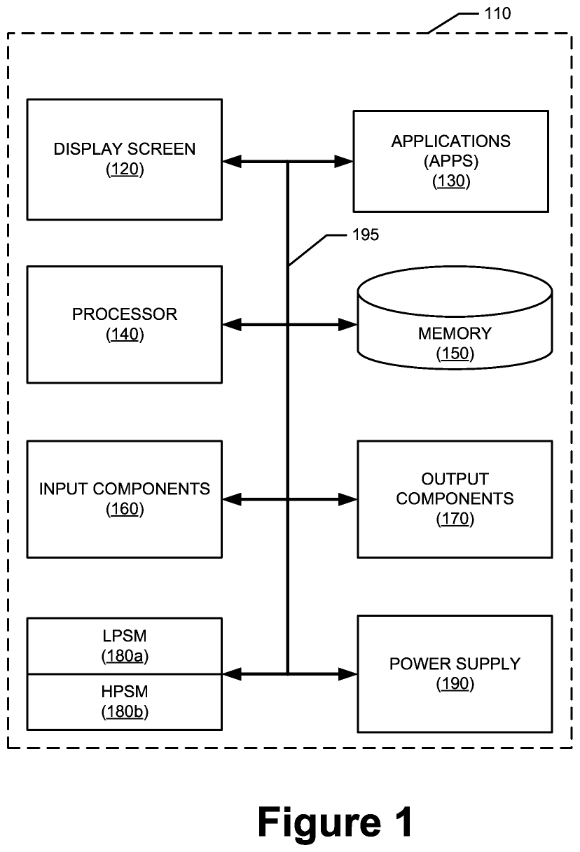

Thus, for example, while FIG. 1 illustrates an example mobile electronic communications device with respect to which embodiments of the disclosed principles may be implemented, it will be appreciated that other device types may be used, including but not limited to laptop computers, tablet computers, and so on. It will be appreciated that additional or alternative components may be used in a given implementation depending upon user preference, component availability, price point and other considerations.

In the illustrated embodiment, the components of the user device 110 include a display screen 120, applications (e.g., programs) 130, a processor 140, a memory 150, one or more input components 160 such as RF input facilities or wired input facilities, including, for example one or more antennas and associated circuitry and logic. The antennas and associated circuitry may support any number of protocols, e.g., WiFi, Bluetooth, cellular, etc.

The device 110 as illustrated also includes one or more output components 170 such as RF (radio frequency) or wired output facilities. The RF output facilities may similarly support any number of protocols, e.g., WiFi, Bluetooth, cellular, etc., and may be the same as or overlapping with the associated input facilities. It will be appreciated that a single physical input may serve for both transmission and receipt.

The processor 140 can be a microprocessor, microcomputer, application-specific integrated circuit, or other suitable integrated circuit. For example, the processor 140 can be implemented via one or more microprocessors or controllers from any desired family or manufacturer. Similarly, the memory 150 is a nontransitory media that may (but need not) reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read-only memory (i.e., a hard drive, flash memory or any other desired type of memory device).

The information that is stored by the memory 150 can include program code (e.g., applications 130) associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications and modules, these typically utilize the operating system to provide more specific functionality, such as file system service and handling of protected and unprotected data stored in the memory 150. In an embodiment, modules are software agents that include or interact with hardware components such as one or more sensors, and that manage the device 110′s operations and interactions with respect to the described embodiments.

In an embodiment, a Low Power Speech Module (LPSM) 180a provides rudimentary speech recognition functions at reduced power to avoid expending power resources for each spoken word while a High Power Speech Module (HPSM) 180b executes similar functions at a higher level of accuracy if a user request has been detected. The functions executed by the Low Power Speech Module 180a and High Power Speech Module 180b will be discussed at greater length in other figures.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

In an embodiment, a power supply 190, such as a battery or fuel cell, is included for providing power to the device 110 and its components. Additionally or alternatively, the device 110 may be externally powered, e.g., by a vehicle battery, wall socket or other power source. In the illustrated example, all or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules and execute programs for initiating different activities such as launching an application, transferring data and toggling through various graphical user interface objects (e.g., toggling through various display icons that are linked to executable applications). As noted above, the device 110 may include one or more display screens 120. These may include one or both of an integrated display and an external display.

There are many possible implementations for the specific elements outlined herein as well as ways in which to order or connect these elements. As such, the figures provide examples of particular implementations, but these examples are non-exhaustive. Factors such as the computing power available on one or more cores, bus speeds, wake times, algorithm efficiencies, and such will dictate the optimal final configuration, using the described principles to reduce power consumption while still providing responsiveness through natural user interaction. As such, other arrangements and details than those shown are contemplated as nonetheless falling within the disclosed principles.

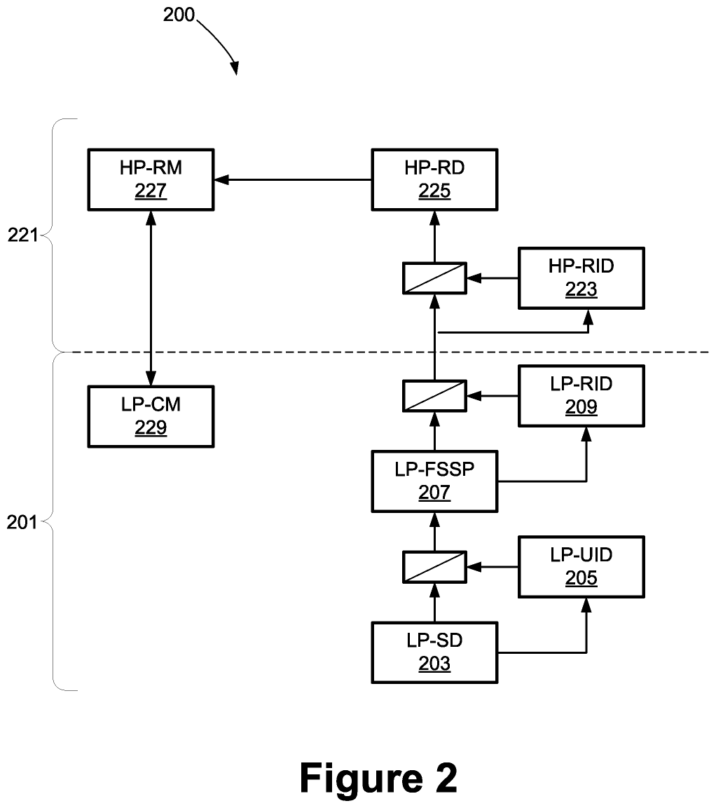

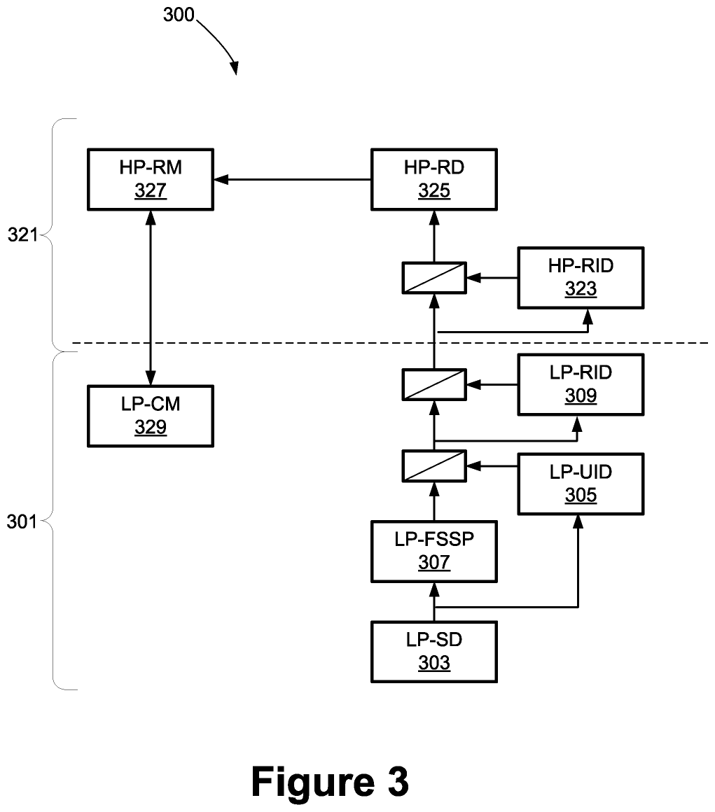

FIGS. 2 and 3 are simplified schematic drawings illustrating component configurations for example embodiments. Turning to FIG. 2 first, this figure shows a configuration in which the results determined by the LP-UID (e.g., the determination as to whether the speaker is an authorized user of the device) are used to gate the passing of audio to the LP-FSSP (frontend speech signal processor). That is, speech from a non-authorized user is not passed to the frontend speech signal processor in this embodiment.

The illustrated system 200 includes a low power section 201 and a high power section 221. Within the low power section 201, the system 200 includes an LP-SD (low power speech detection module) 203, which is configured to detect potential speech in an incoming audio signal, e.g., raw audio from a mic or digitizer. While the foregoing is occurring, the low power section 201 of the system 200 also buffers a short window of speech, e.g., 20 seconds, for use to provide context if needed.

The LP-SD 203 passes the raw audio signal to the LP-UID module 205, which determines whether the voice is that of the authorized user. This determination is not based upon the utterance of special data, such as secret phrases or pass word sequences. Rather, the audio itself is voice-matched or voice-rejected.

If the LP-UID module 205 outputs a signal that the speaker is the authorized user, the raw audio from the LP-SD 203 is gated ahead to the LP-FSSP 207, which isolates the authorized user's speech by filtering out other speakers, echoes, and miscellaneous noise. The LP-FSSP 207 provides the filtered speech to the LP-RID 209 which identifies a request structure, if any, in the filtered speech and generates a first request score indicating the likelihood that a request structure is present. A request structure in speech generally includes an anchor word, which is any one of a significant number (e.g., greater than 10) of such words, as well any modifier words, and perhaps other words as well.

If the first request score indicates a probability above a certain level (e.g., 50%) that a request structure is present, the filtered speech is gated across to the high power section 221 of the system 200. Within the high power section 221 of the system 200, an initial gating occurs based on a higher accuracy determination as to whether there is truly a request structure present in the filtered speech. To this end the HP-RID 223 generates a second request score indicating the likelihood that a request structure is present.

If the second request score indicates an acceptable probability (e.g., 90%) that a request structure is present, the raw speech is then gated forward to the HP-RD 225, which parses the identified request into component parts and translates it into an actionable string (e.g., when user is within defined coordinates, issue reminder to user that states “get milk”). Finally, the HP-RM 227 receives the actionable string and coordinates its execution, e.g., by executing or scheduling tasks and setting trigger times, locations, etc. The HP-RM 227 is also linked to the LP-CM 229 to receive any relevant context information bearing on execution of the request, e.g., the user's calendar, location and so on.

As noted above, there are other ways to implement the described principles, and to this end, FIG. 3 shows a second component configuration example, wherein the LP-FSSD processing is handled in parallel with the LP-UID processing. In this example, there is again a low power section 301 and a high power section 321 of the system 300.

Within the low power section 301, the system 300 includes an LP-SD (low power speech detection module) 303, which is configured to detect potential speech in an incoming audio signal, e.g., raw audio from a mic or digitizer. As with the prior embodiment, the low power section 301 of the system 300 may also buffer a short window of speech, e.g., 20 seconds, for use to provide context if needed.

The raw audio is passed to the LP-UID module 305, which determines whether the voice is that of the authorized user. As in the prior implementation, this determination is not based upon the utterance of special data, such as secret phrases or pass word sequences. In parallel, the raw audio is also passed to the LP-FSSP 307, which isolates any speech through filtering.

If the LP-UID module 305 outputs a signal that the speaker is the authorized user, the filtered speech is gated from the LP-FSSP 307 to the LP-RID 309 which then identifies a request structure, if any, in the filtered speech and generates a first request score indicating the likelihood that a request structure is present. As above, a request structure in speech includes an anchor word, as well any modifier words, and perhaps other words as well.

If the first request score indicates an acceptable probability (e.g., 90%) that a request structure is present, the filtered speech is gated across to the high power section 321 of the system 300. Within the high power section 321 of the system 300, an initial gating occurs based on a higher accuracy determination as to whether there is truly a request structure present in the filtered speech. To this end the HP-RID 323 generates a second request score indicating the likelihood that a request structure is present.

If the second request score from the HP-RID 323 indicates an acceptable probability (e.g., 90%) that a request structure is present, the raw speech is then gated forward to the HP-RD 325, which parses the identified request into component parts and translates it into an actionable string. Finally, the HP-RM 327 receives the actionable string and coordinates its execution, e.g., by executing or scheduling tasks and setting trigger times, locations, etc. As with the prior embodiment, the HP-RM 327 is also linked to the LP-CM 329 to receive any relevant context information bearing on execution of the request, e.g., the user's calendar, location and so on.

Although the features of the various components are likely clear from the foregoing, additional details are provided regarding these elements. The LP-SD is configured to analyze audio to identify speech, if present. It does not filter or otherwise alter the audio. When it determines that there is human speech being received by the microphone it will signal downstream elements and allow the audio to pass as noted above. In a simple embodiment, the LP-SD is a Voice Activity Detector (VAD) that searches for sound within the expected range of human speech.

The LP-UID receives either unprocessed audio from the microphones (e.g., in system 200) or processed audio from the LP-FSSP (e.g., in system 300) and verifies that the audio contains speech belonging to a stored speech signature of the device's user. There are known algorithms that provide this function, although any selected algorithm would ideally have a low false acceptance rate (FAR) and a low false rejection rating (FRR). Suitable speaker verification algorithms for use in the LP-UID include neural network based algorithms, Hidden Markov Model (HMM), and others.

As with the LP-SD, the LP-UID does not modify the audio, but rather only acts as a check to see if the authorized user's speech is detected. When such speech is detected, the LP-UID signals downstream elements of the event and allows the audio to be passed to them in the event that they are not already receiving the audio from a different path.

The LP-FSSP as illustrated receives unprocessed audio, e.g., from one or more microphones. Its passage of the audio stream is gated on upstream elements. Those of skill in the art will appreciate that there are many suitable methods to fulfill the role of this component, including echo cancelling, beam forming, speech signal boosting, and so on. Each technique will in some way modify the audio and the resulting modified audio stream will be passed downstream as appropriate.

The LP-RID receives the modified audio from the LP-FSSP. In an embodiment, the LP-RID is a detector that contains both an ASR (automatic speech recognizer) for converting speech audio into text and an NLU (natural language unit) configured to search for and recognize defined structural elements within the converted text from the ASR.

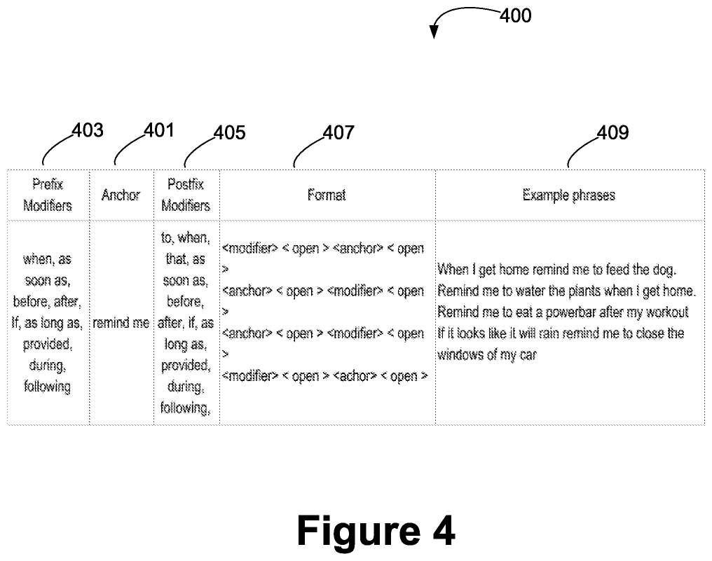

An example of the structural elements of request to “remind me” is shown in tabular format in FIG. 4. In an embodiment, the defined structural elements 400 within the converted text include an anchor word or phrase 401 (e.g., “remind me”) without which the request is not detectable as a request. In this sense, the anchor differentiates a request from non-request speech.

The defined structural elements also optionally contain a modifier, which may be either a prefix modifier 403 or a postfix modifier 405. Modifiers include one or more words commonly associated with an anchor, although even when taken in conjunction with the anchor, the request may not yet be complete. Modifiers primarily provide temporal, physical, or other tagging and logical structure to the request. There are a limited number of modifiers for a given anchor. As noted above, there may be no modifier associated with a given anchor.

The defined structural elements may also include other words 405 that provide details of the request. There are almost an infinite number of possible combinations of other words that could accompany an anchor. In an embodiment, at least one other word is needed, though there is no technical limit to how many other words could be included with a given request.

When the other word or words, if any, are combined with the anchor and the modifier, as in one of the structure formats 407 shown in FIG. 4, the request structure is complete. The anchor and modifier are used for purposes of detecting a request, but the other may be ignored. In an embodiment, for the purposes of detection, the order of the anchor, modifier, and other words in a phrase relative to each other does not matter.

Complete request statements 409 are shown in the last column of the table. The first example employs a prefix modifier and, parsed with annotations, appears as:

Modifier—“When

Other—“I get home”

Anchor—“remind me”

Modifier—“to”

Other—“feed the dog.”

The second example employs a postfix modifier and, parsed with annotations, appears as:

Anchor —“Remind me”

Modifier—“to”

Other—“water the plants”

Modifier—“when”

Other—“I get home.”

The third example employs a postfix modifier and, parsed with annotations, appears as:

Anchor—“Remind me”

Modifier—“to”

Other—“eat a power bar”

Modifier—“after”

Other—“my workout.”

The fourth example employs a prefix modifier and, parsed with annotations, appears as:

Modifier—“If it looks like it will rain”

Anchor—“remind me”

Modifier—“to”

Other—“close the windows of my car.”

The LP-RID can be, and in an embodiment is, less accurate than the HP-RID but is configured to resolve close calls in favor of identifying a request as being present. So the FAR of the LP-RID may be high compared to traditional standards, but the FRR should be nearly zero. This will ensure that almost every potential request gets more fully analyzed while reducing the frequency with which the high power components are invoked.

The LP-CM is a service that runs in the low power domain to monitor context events such as the user standing up, the user walking, the user uttering a request, a significant change in the ambient noise around the user, and so on. In an embodiment, the HP-RM sends requests to the LP-CM to monitor for specific combinations of contextual information. When the LP-CM detects the specified events, it will signal the HP-RM that the events have occurred. In this way, the HP-RM need not stay active awaiting trigger events.

The HP-RID is similar in purpose and function to the LP-RID, but utilizes a far more powerful ASR and NLU. So rather than achieving a high FAR and very low FRR, the HP-RID is configured to now drive the FAR to zero as well through higher accuracy and consequent higher power consumption, while maintaining the FRR at near 0%.

The HP-RD takes the audio once the HP-RID has verified the utterance as a request and parses the audio to identify the details of the request being made. The HP-RD may be combined with the HP-RID NLU or kept separate. In addition to an NLU component, the HP-RD may also contain or link to a knowledge graph of the user for use in understanding user-specific request context such as the user's home location, work location, parking location(s), sleep schedule (typical sleeping and waking times), the user's (or device's) motion or activity, and so on.

The HP-RM receives the decoded output from the HP-RD and, working with the LP-CM as noted above, monitors the user device and the user's context to identify when and how to fulfill the user's request. Some requests will require an immediate response while others will be delayed, e.g., to await locational or temporal trigger events. The HP-RM may include a natural language generator (NLG) or other generator for crafting responses and prompts to the user, to be delivered at the appropriate time based on the nature of the request and the contextual information.

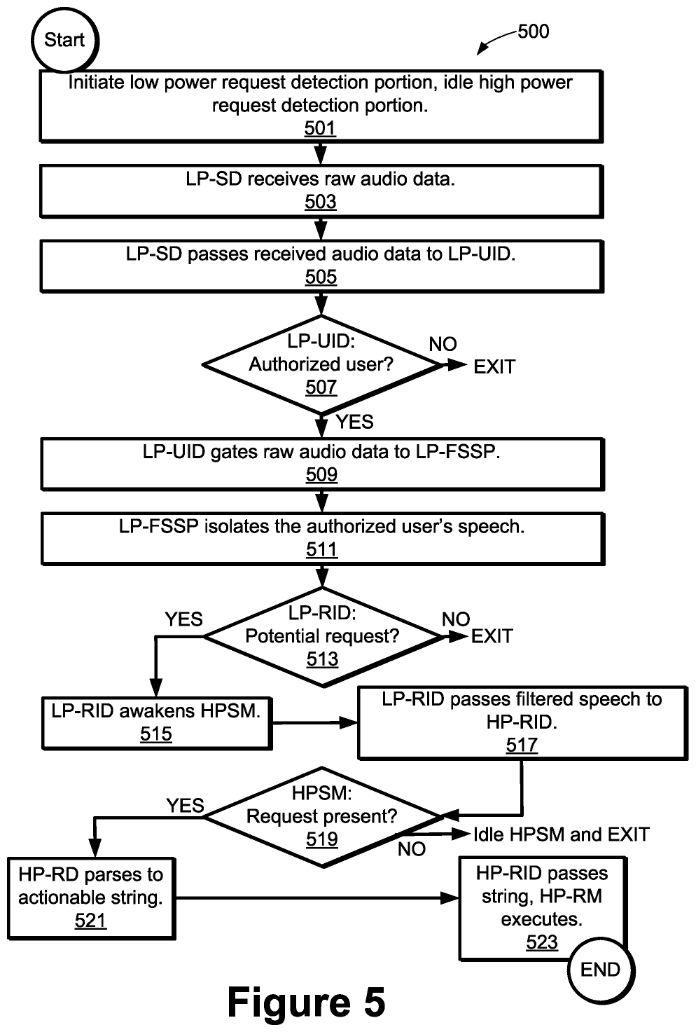

FIG. 5 is a flow chart showing a process of tiered voice detection and processing in accordance with an embodiment of the disclosed principles. The illustrated process 500 begins at stage 501, wherein device, such as device 110 or otherwise, initiates a low power request detection portion, such as the LPSM 180a, while idling a high power request detection portion, e.g., HPSM 180b.

At stage 503, LP-SD 203 receives raw audio data, e.g., from a mic or network connection, that potentially contains speech and passes the received audio data to the LP-UID 205 at stage 505. The LP-UID 205 then determines at stage 507 whether the speech in the audio data corresponds to the voice of an authorized user of the device 110. If the audio data corresponds to the voice of an authorized user of the device 110, the LP-UID 205 produces a signal at stage 509 to gate the raw data forward within the LPSM 180a to the LP-FSSP 207.

At stage 511, the LP-FSSP 207 performs low power speech processing on the raw audio data by filtering and voice isolation or other processes to isolate the authorized user's speech, so that in stage 513, the LP-RID 209 is able to determine whether the audio contains a potential request by the user. A potential request might be identified by the presence of an anchor word, for example, and may thus have a request score (e.g., likelihood or confidence level) of a normally unacceptable level, e.g., 50%.

If the speech does contain a potential request, the LP-RID 209 awakens the HPSM 180b at stage 515, which may include an application processor or other high power processor, and gates the preliminarily filtered speech forward to the HP-RID 223 at stage 517.

Within the HPSM 180b, the HP-RID 223 performs high power request identification on the filtered speech at stage 519 to generate a second request score indicating the likelihood that a request structure is present within the filtered speech. If the second request score does not meet a predetermined level such as 90%, the HPSM 180b is again idled.

Otherwise, the filtered speech is gated by the HP-RID 223 to the HP-RD 225, which, at stage 521, parses the request into its component parts and translates it into an actionable string. At stage 523, the HP-RID 223 passes the actionable string to HP-RM 227, which coordinates its execution, e.g., by executing or scheduling tasks and setting trigger times, locations, etc. As noted above, the LP-CM 229 may provide context information to the HP-RM 227 e.g., the user's calendar, location and so on.

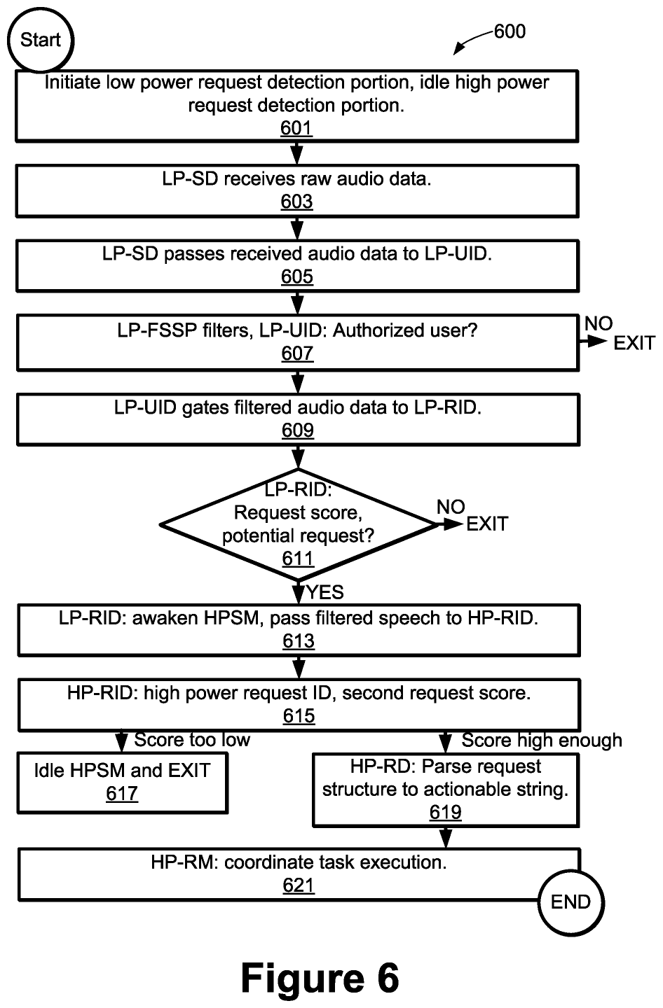

FIG. 6 is a flow chart showing an alternative process of tiered voice detection and processing in accordance with another embodiment of the disclosed principles. This embodiment is in accordance with the architecture shown in FIG. 3.

The illustrated process 600 begins at stage 601, wherein device, e.g., device 110, initiates a low power request detection portion, such as the LPSM 180a, while idling a high power request detection portion, e.g., HPSM 180b. At stage 603, LP-SD 303 receives raw audio data, e.g., from a mic or network connection, that potentially contains speech, and passes the received audio data to the LP-UID 305 and LP-FSSP 307 at stage 605.

At stage 607, the LP-UID 305 determines whether the speech in the audio data corresponds to the voice of an authorized user of the device 110 while the LP-FSSP 307 performs preliminary filtering of the raw audio to isolate the speech. If the audio data corresponds to the voice of an authorized user of the device 110, the LP-UID 305 produces a signal at stage 609 to gate the filtered data forward from the LP-FSSP 307 to the LP-RID 309.

At stage 611, the LP-RID 309 determines whether the filtered audio contains a potential request by the user. As noted above, a potential request might be identified solely by the presence of an anchor word, for example, and may thus have a request score (e.g., likelihood or confidence level) of a normally unacceptable level, e.g., 60%.

If the speech does contain a potential request, then at stage 613 the LP-RID 309 awakens the HPSM 180b and gates the preliminarily filtered speech forward to the HP-RID 323. The HP-RID 323 performs high power request identification on the filtered speech at stage 615 to generate a second request score indicating the likelihood that a request structure is present within the filtered speech. If the second request score does not meet a predetermined level such as 90%, the HPSM 180b is again idled at stage 617.

Otherwise, the filtered speech is gated by the HP-RID 323 to the HP-RD 325, which, at stage 619, parses the request into its component parts and translates it into an actionable string. The HP-RID 323 passes the actionable string to HP-RM 327, which coordinates its execution at stage 621, e.g., by executing or scheduling tasks and setting trigger times, locations, etc. As with the process 500, the LP-CM 329 may provide context information to the HP-RM 327 e.g., the user's calendar, location and so on.

It will be appreciated that various systems and processes have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A system for user request detection and execution comprising:
a mobile electronic communications device;
a low power request detection module implemented on the mobile electronic communications device, the low power request detection module having a first operating power consumption;
a high power request detection module implemented on the mobile electronic communications device, the high power request detection module having a second operating power consumption and an idling power consumption, and wherein the second operating power consumption exceeds the first operating power consumption and both the first operating power consumption and the second operating power consumption exceed the idling power consumption;
a first processor implementing the low power request detection module, configured to detect speech, determine whether the detected speech is that of an authorized user of the mobile electronic communications device, determine via a first confidence threshold that the speech of the authorized user contains a request to the mobile electronic communications device, and to thereupon prompt the high power request detection module to awaken from idle; and
a second processor implementing the high power request detection module and configured to awaken from idle when prompted by the low power request detection module, and to determine with a second confidence threshold that the speech of the authorized user contains a request to the mobile electronic communications device, the second confidence threshold being higher than the first confidence threshold, and to execute the request.

2. The system in accordance with claim 1, wherein the first processor and second processor are separate processors.

3. The system in accordance with claim 1, wherein the first processor is a device processor and the second processor is an application processor.

4. The system in accordance with claim 1, wherein the first processor and second processor are the same processor.

5. The system in accordance with claim 2, wherein the first processor is further configured to gather user context information and to pass gathered user context information to the second processor.

6. The system in accordance with claim 5, wherein the user context information comprises at least one of a user location, user home location, user work location, user parking location, user sleep schedule, user motion, device motion, user activity and device activity.

7. The system in accordance with claim 1, wherein determining with a second confidence threshold that the speech of the authorized user contains a request comprises determining that the speech contains a request anchor associated with a request modifier.

8. The system in accordance with claim 7, wherein determining with a second confidence threshold that the speech of the authorized user contains a request further comprises determining that the speech contains at least one other word that is not a request anchor or a request modifier.

9. A method for user request detection and execution in a mobile electronic communications device comprising:
activating a first request processing module to operate a first operational power;
detecting speech via the first request processing module;
determining whether the detected speech is that of an authorized user of the mobile electronic communications device via the first request processing module;
determining with a first confidence threshold that the speech of the authorized user contains a request to the mobile electronic communications device;
awakening a second request processing module from an idle state based upon the determination that that the speech of the authorized user contains a request, to operate at a second operational power which is greater than the first operational power;
determining via the second request processing module with a second confidence threshold higher than the first confidence threshold that the speech of the authorized user contains a request to the mobile electronic communications device; and
executing the request via the second request processing module.

10. The method in accordance with claim 9, wherein the first request processing module is implemented by a first processor and the second request processing module is implemented by a second processor.

11. The method in accordance with claim 9, wherein the first processor is a device processor and the second processor is an application processor.

12. The method in accordance with claim 9, wherein the first processor and second processor are the same processor.

13. The method in accordance with claim 10, further comprising gathering user context information by the first request processing module and passing the user context information to the second request processing module.

14. The method in accordance with claim 13, wherein the user context information comprises at least one of a user location, user home location, user work location, user parking location, user sleep schedule, user motion, device motion, user activity and device activity.

15. The method in accordance with claim 9, wherein determining via the second request processing module with a second confidence threshold higher than the first confidence threshold that the speech of the authorized user contains a request to the mobile electronic communications device further comprises determining that the speech contains a request anchor associated with a request modifier.

16. The method in accordance with claim 15, wherein determining via the second request processing module with a second confidence threshold higher than the first confidence threshold that the speech of the authorized user contains a request to the mobile electronic communications device comprises determining that the speech contains at least one other word that is neither a request anchor nor a request modifier.
